(19) United States
(12) Patent Application Publication
(10) Pub. No.: US 2013/0104709 A1
(43) Pub. Date: May 2, 2013

(54) SELF-CLEANING DEVICE FOR PROCESSING FOOD PRODUCTS

(71) Applicant: Weber Maschinenbau GmbH Breidenbach, Breidenbach (DE)

(72) Inventor: Ingo Rother, Breidenbach (DE)

(73) Assignee: Weber Maschinenbau GmbH Breidenbach, Breidenbach (DE)

(21) Appl. No.: 13/661,990

(22) Filed: Oct. 26, 2012

(30) Foreign Application Priority Data
Oct. 28, 2011 (DE) 102011117315.7

(51) Int. Cl. B26D 7/08; B26D 7/18; B65G 45/10; B65G 45/12; B65G 45/18; B26D 7/32; B08B 1/02

(52) U.S. Cl. CPC B26D 7/088; B26D 7/32; B26D 7/1863; B08B 1/02; B65G 45/12; B65G 45/18; B65G 45/10
USPC 83/23; 83/155; 83/100; 134/9; 198/494; 198/497; 198/496

(57) ABSTRACT

The invention relates to a device for slicing food products which can have a non-homogeneous structure. The device comprises a supply device, a cutting device, namely the slicer, and a removal device, preferably an endless conveyor belt. It is provided to have the device be designed to be self-cleaning. Sterilization of the device is likewise provided.

### CROSS-REFERENCE TO RELATED APPLICATIONS

This application claims priority to German Patent Application 10 2011 117315.7 filed on Oct. 28, 2011, which is hereby incorporated by reference in its entirety.

### TECHNICAL FIELD

The disclosure relates to a device for slicing food products, such as solid sausages or ham, having the features of the preambles of claims 1, 10 and 14, and a conveyor belt formed as an endless belt according to the preamble of claim 16. The disclosure also relates to a method for slicing food products according to the preamble of claims 20 and 21 and a method for cleaning an endless conveyor belt according to the preamble of claim 22.

### BACKGROUND

Devices for slicing food products such as solid sausages or ham are known. WO 03/028 964 A1, for example, describes a device for slicing in which the food products are supplied to a cutting area by means of a supply device. In this cutting area, the food products are sliced into slices using a cutting knife The sliced food products are removed from the cutting area in the form of product slices using a removal device comprising one or more conveyor belts formed as endless belts. In this, it is provided to clean the gap between the cutting area and the removal device and the lighting device which is to illuminate the area of the gap.

It has shown during operation of the device for slicing food products that the cleaning described in WO 03/028 964 A1 of the gap and of the illumination device is not sufficient.

The disclosure is therefore based on the object to design the devices for slicing food products on the whole and the method used for this such that the requirements are properly met in terms of operations and hygiene.

The object features specified in claims 1, 10 and 14 as well as the method steps specified in claims 20, 21 and 22 are proposed to satisfy this object.

### SUMMARY

The device according to the disclosure is a device for slicing food products comprising a supply device, a cutting device, namely the slicer, and a removal device.

Contamination occurs continuously during operation of the device according to the disclosure. This may be caused by the structure and consistency of the food product, by mechanical action upon the food product during the supply process, as well as the cutting process itself, and during removal.

Therefore, there is the need for cleaning and sterilization during each phase of operation of the device for slicing food products.

For eliminating contamination of the supply device of the slicer, of the removal device and the cutting device, devices are accordingly to be provided with which the supply device, the slicer and the removal device are designed to be self-cleaning.

Advantageously, the devices for self-cleaning are operated during production breaks.

It has also shown to be advantageous, however, to operate the devices for self-cleaning during production.

As a means for operating the device for self-cleaning, the use of a cleaning liquid has proven successful. The cleaning liquid is preferably applied onto the areas to be cleaned by means of spray heads, so-called spray balls, where the spray balls are provided at the ends of lines for the cleaning liquid. The spray balls have a plurality of apertures designed as nozzles, so that the application of the cleaning liquid can thereby be acted upon.

For removal of the cleaning liquid, drain devices can advantageously be provided at the slicer and/or the supply device and/or the removal device. If this drain device is omitted, it is proposed to advantageously remove the cleaning liquid to be discharged via drain devices on the floor.

During embodiment of the disclosure, it has been found to be particularly advantageous to provide devices for drying and/or rinsing of preferably the cleaning liquid at the device for slicing the food products, i.e. the slicer, the supply device, and the removal device. Furthermore, devices for disinfection can be provided.

In a particular embodiment of the disclosure, it is provided that there are devices in the slicer, and preferably both in the supply device as well as in the removal device by, means of which the slicer as well as the supply and the removal device can be sterilized. This can be done both during production breaks as well during production.

Sterilization can be performed using steam or peroxide, preferably hydrogen peroxide. Ozone lamps can likewise be used for this purpose.

In a further preferred embodiment of the disclosure, a suction unit for sucking away cutting powder is provided in the production zone of the slicer. Cutting powder regularly accumulates during production. By having the suction unit suck it away, contamination is prevented in the immediate production area and the associated and downstream parts of the system. Preferably, the cutting powder is sucked away during production.

A conveyor belt or a plurality of conveyor belts is provided for removal of the food products sliced in the slicer. As the conveyor belts also need to be cleaned, a device is provided according to the disclosure for continuous cleaning of the conveyor belt or the conveyor belts.

Continuous cleaning can preferably take place in that the lower portion of the conveyor belt is guided through a cleaning liquid. In order to avoid contamination of the food products with the cleaning liquid, it is preferably provided to design the conveyor belt with devices for scraping off the cleaning liquid after it exits the cleaning liquid, where a device for brush-cleaning the conveyor belt can advantageously be provided.

Subject matter of the disclosure is also to provide a method for slicing food products with an inhomogeneous structure, in which the food products are supplied to a slicer and removed from the slicer with a removal device, wherein one or more of the devices involved in the method are preferably cleaned by suction.

Furthermore, the disclosure gears toward a method for slicing food products, in which the devices involved in the method are preferably sterilized by means of steam, peroxide, in particular hydrogen peroxide, or ozone lamps.

The disclosure is also geared towards a method for cleaning an endless conveyor belt which is used for the removal of the food cut by the slicer, in which the lower portion of the endless conveyor belt is guided through a cleaning liquid and where the cleaning liquid is subsequently scraped off from the endless conveyor belt, and where the endless conveyor belt is then brushed off.

An embodiment of the disclosure is described below with reference to the drawings.

### BRIEF DESCRIPTION OF THE DRAWINGS

FIG. 1: shows a device for slicing food products according to a first embodiment of the disclosure,

FIG. 2: shows a device for slicing food products according to a second embodiment of the disclosure,

FIG. 3: shows a spray ball for the device according to the disclosure,

FIG. 4: shows a device for slicing food products according to a third embodiment of the disclosure, and

FIG. 5: shows a device for slicing food products according to a fourth embodiment of the disclosure.

### DETAILED DESCRIPTION

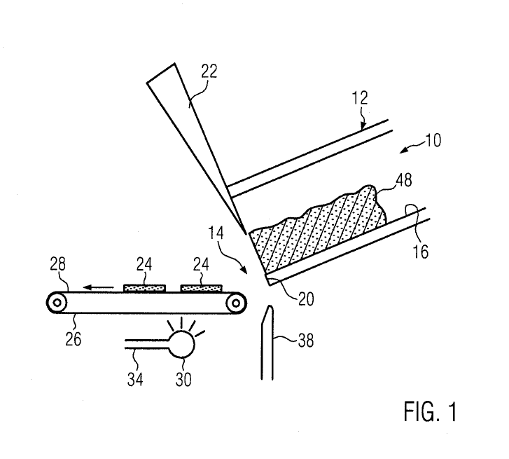

FIG. 1 illustrates a device for slicing food products 10 which can have a non-homogeneous structure. These food products 10 are predominantly raw or cooked ham, which in addition to the meat portion also comprise inclusions of fat. Likewise, food products 10 to be sliced also include sausages and cheeses, which can likewise have a non-homogeneous structure.

The food products 10 to be sliced are supplied to the cutting area 14 by means of a supply device 12. The supply device 12 comprises a supporting surface 16 into which a feeding device 18 is usually integrated. The supporting surface 16 comprises a cutting edge 20 in its front portion. By rotating the cutting knife 22, product slices 24 are sliced off.

The cutting movement of the cutting knife 22 is preferably created in that the cutting knife 22 is mounted eccentrically and therefore rotates about an axis that does not correspond to the center of the cutting knife.

The product slices 24 are supplied to a removal device 26 or fall onto the removal device 26 due to the inclination of the supply device 12.

The removal device 26 can be formed by an endless conveyor belt 28. However, a plurality of endless conveyor belts 28 is preferably used.

The endless conveyor belt 28 or the endless conveyor belts 28 are adjustable in their conveying speed so that the product slices 24 are removed in a separated manner. It is also provided to clock the one or more endless conveyor belts 28 such that the product slices 24 can be stacked straight or in an offset manner, so that the product slices 24 can respectively be removed in stacks.

The entire device for slicing food products 10 is designed to be self-cleaning.

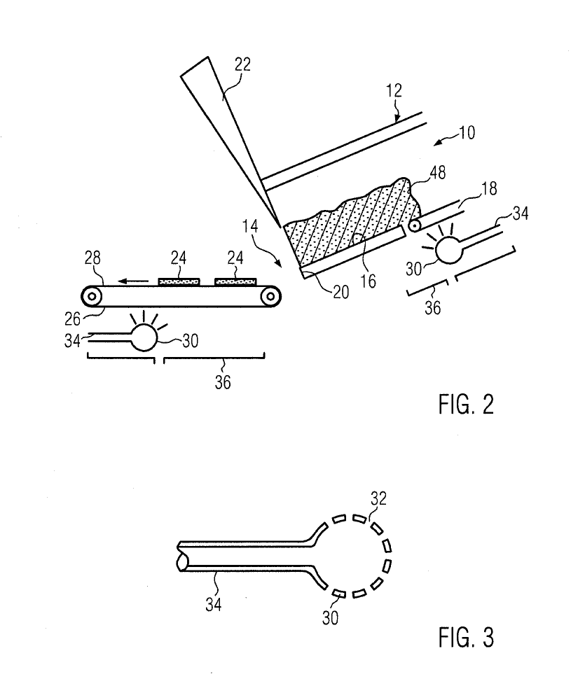

As shown in FIG. 2, in the supply device 12, a feeding device 18 can advantageously be provided which can be formed like an endless conveyor belt. The feeding device 18 can preferably be cleaned continuously by wiping lips, brushes or scrapers. Contamination can also be cleaned using a compressed air jet or a water jet. In this, it has been found to be particularly advantageous to apply the compressed air and/or the water jet in a pulsed manner onto the surfaces to be cleaned.

The feeding device 18 integrated in the supply device 12 can also be provided with wipers and/or scrapers, so that the supply device 12 can as a whole be cleaned continuously.

As shown in FIGS. 1 and 2, both the supply device 12 as well as the cutting section 14 can be advantageously cleaned with a cleaning liquid. For applying the cleaning liquid, spray heads, so-called spray balls 30, can advantageously be used.

The spray balls 30 illustrated in FIG. 3 are preferably spherically-shaped structures comprising openings 32 along their surfaces. These openings 32 can be formed as nozzles. The cleaning liquid is conveyed by means of lines 34 to the spray balls 30.

The cleaning liquid exits from the spray balls 30 at a high pressure, so that the cleaning liquid impacts with momentum onto the surfaces to be cleaned. Due to the momentum and the composition of the cleaning liquid, a cleaning effect is achieved.

The lines 34 and the spray balls 30 may be of such nature, that the cleaning liquid impacts the surfaces to be cleaned at different angles.

Water is a cleaning liquid first to be considered. The water can have specific cleaning agents added to it. Degreasers have here proven to be particularly suitable.

An oxidizing agent can be added to the cleaning liquid, where hydrogen peroxide diluted with water has presently proven to be successful.

Liquids for cleaning are advantageously usable both in the supply device 12, the cutting area 14 as well as in the removal device 26. The consumed cleaning liquid, however, must also be removed from the device for slicing food products 10.

The collection devices 36 shown in FIG. 2 have proven to be successful. The consumed cleaning liquid at atmospheric pressure drops into the collection devices 36 being provided beneath the respective devices for slicing food products 10. Should it be disadvantageous from an operational or structural perspective, that the collection devices 36 be provided directly at the devices for slicing food products 10, then drain facilities can also be provided at the floor.

The devices for slicing food products 10 are further provided with devices for rinsing off cleaning liquid and devices for drying the rinsed elements. Compressed air, warm air and radiant heaters can be considered for drying.

It is also intended to disinfect the entire device for slicing food products 10. For this, additives to the cleaning liquid as well as ultra-violet radiators can predominantly be considered.

For cleaning in particular the cutting area 14, it has proven to be advantageous, as illustrated in FIG. 1, to provide devices for extraction by suction 38.

The devices for extraction by suction 38 comprise a suction nozzle and connection lines to a vacuum generator. In particular, the use of the device for extraction by suction 38 has proven to be successful in the cutting area 14. Leftovers from the sliced food products in the form of cutting powder accumulate due to operating conditions. This cutting powder, being quite dry itself, can be formed to somewhat more compact conglomerates when there is a higher fat content of the food to be sliced or by fat dripping down.

In an advantageous manner, the supply device 12 and the removal device 26 can be cleaned using the device for extraction by suction 38. For the supply device 12, this applies mainly to parts of the food, which have become detached during transportation or have been separated in the supply device 12 and to parts of the food that have fallen out from the production path in the cutting area 14.

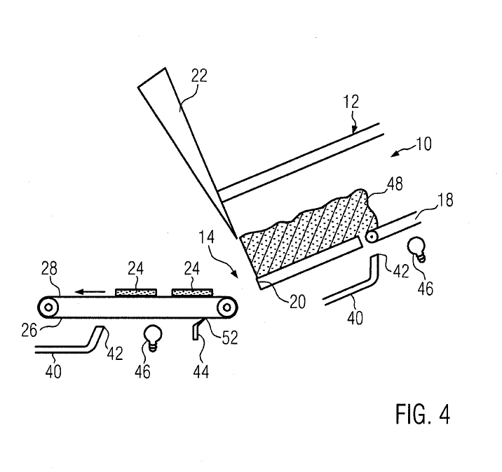

As shown in FIG. 4, sterilizing devices 40 are provided at the supply device 12, the cutting area 14 and the removal device 26. Nozzles 42 can be provided at the supply device 12, in the cutting area 14 and at the removal device 26 for water vapor impingement. Preferably, low-pressure steam of about 2 bars is used. The condensate forming on the elements acted upon by the steam is removed, preferably using scrapers 44.

Sterilization with peroxides is likewise intended, where this is preferably hydrogen peroxide due to its highly oxidizing effect. Due to its instability, hydrogen peroxide is diluted with water so that it is applied preferably in a concentration of 30%. After application of the peroxide and a specified period of exposure, the residual peroxide-water mixture is removed.

The use of ozone lamps 46 has proven an excellent means for sterilizing the supply device 12, the cutting area 14 and the removal device 26.

With ozone lamps 46, inter alia the part of the endless conveyor belts 26 are irradiated, which are not loaded with food products 10 or product slices 24. Accordingly, ozone lamps can also be used during production.

The device for slicing food products 10 also comprises a removal device 26 being formed by one or more endless belts.

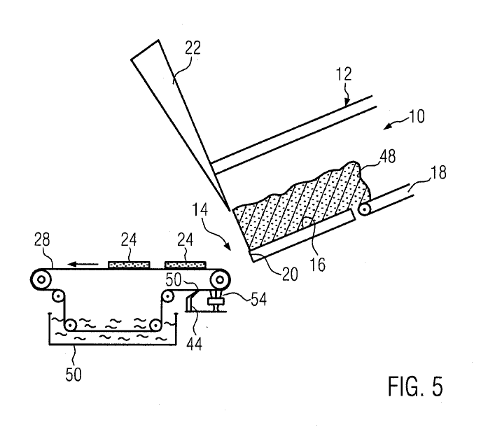

As shown in FIG. 5, the product slices are conveyed in the top region of the endless belts. The lower region of the endless belts is subjected to continuous and/or temporary cleaning. For this, the lower region of the endless belts can be advantageously passed through a cleaning bath 50. If necessary, it is also possible for the lower region of the endless belts to preferably be sprayed with cleaning liquid using spray balls. In any case, it is favorable to scrape off the excess and the used cleaning liquid. This scraping can preferably be performed using elastic wiper lips 52 or using brushes 54.

1. A device for slicing food products such as solid sausages or ham, where said food products can have a non-homogeneous structure, and where said food products can be supplied by means of a supply device to a cutting device, namely, a slicer, and said food products cut into slices in said slicer are removed by a removal device; said removal device may be formed by one or more endless belts, comprising:
devices provided in said slicer, in said supply device, or said removal device; to self clean said slicer, and said supply device and/or said removal device and/or said cutting device to be self-cleaning.

2. The device for slicing food products according to claim 1, wherein said devices for self-cleaning of said slicer, and of said supply device and said removal device are operable during production breaks.

3. The device for slicing food products according to claim 1, wherein said devices for self-cleaning of said slicer, said supply device and said removal device are operable during production.

4. The device for slicing food products according to claim 1, wherein said devices for self-cleaning of said slicer, said supply device and said removal device are operable with a cleaning liquid.

5. The device for slicing food products according to claim 1, wherein said devices to self-clean said slicer, said supply device and said removal device are operable with a cleaning liquid, where said cleaning liquid can be sprayed onto the area to be cleaned using spray balls.

6. The device for slicing food products according to claim 5, further including spray balls at the end of lines for said cleaning liquid, said spray balls comprising a plurality of openings formed as nozzles from which said cleaning liquid can exit.

7. The device for slicing food products according to claim 4, wherein drain facilities for said cleaning liquid are provided in at least one of at said slicer, and said supply devices or said removal devices.

8. The device for slicing food products according to claim 4, wherein no drain facilities for said cleaning liquid are provided at said slicer and at said preferably provided supply devices and said removal devices, so that said cleaning liquid is dischargeable via drain facilities at a floor.

9. The device for slicing food products according to claim 1, further including devices for drying and/or devices for rinsing and/or devices for disinfection provided in at least one of said slicer, and said supply devices and said removal devices.

10. A device for slicing food products such as solid sausages or ham, where said food products can have a non-homogeneous structure, and where said food products can be supplied by means of a supply device to a cutting device, namely, a slicer, and said food products cut into slices in said slicer are removed by a removal device; said removal device is formed by an endless belt, comprising:
devices are provided in at least one of said slicer, said supply device and said removal device; to sterilize said slicer and said supply device and said removal device.

11. The device for slicing food product according to claim 10, wherein said devices for sterilizing said slicer said supply device and said removal device are operable during production breaks.

12. The device for slicing food product according to claim 10, wherein said devices for sterilizing said slicer said supply device and said removal device are operable during production.

13. The device for slicing food products according to one claim 10, wherein steam, peroxide or ozone lamps are used for sterilizing.

14. The device for slicing food products such as solid sausages and ham, where said food products can have a non-homogeneous structure and are cut into slices in a slicer, said device comprising:
a suction unit for sucking away cutting powder is provided in the production zone of said slicer.

15. The device for slicing food products according to claim 14, wherein said cutting powder is sucked away during production.

16. A conveyor belt comprising as an endless belt, adapted to remove food products cut into slices in a slicer, wherein
said food products are transported in the upper portion of said conveyor belt, and a device for continuous cleaning of said conveyor belt is provided in the lower portion of said conveyor belt.

17. The conveyor belt according to claim 16, wherein said lower portion of said conveyor belt is cleaned with a cleaning liquid, said lower portion of said conveyor belt is guidable through a cleaning liquid.

18. The conveyor belt according to claim 16, further including devices for scraping off cleaning liquid, said devices provided at said lower portion of said conveyor belt.

19. The conveyor belt according to claim 16, further including devices for brushing said conveyor belt provided at said lower portion of said conveyor belt.

20. A method for slicing food products having a non-homogeneous structure like solid sausages or ham, comprising:
supplying food products to a slicer by means of a supply device, cutting said food products into slices in said slicer, and removing said slices from said slicer by a removal device, wherein during production breaks and/or during production, at least one of the devices involved and/or said slicer are preferably cleaned by suction.

21. A method for slicing food products having a non-homogeneous structure like solid sausages or ham, comprising:
supplying food products to a slicer by a supply device, cutting said food into slices in said slicer, and from said slicer by a removal device, and sterilizing at least one of the devices or slicer by steam peroxide or zone lamps during production breaks or during production.

22. A method for cleaning an endless conveyor belt being downstream of a device for slicing food products having a non-homogeneous structure, comprising:
cleaning a lower portion of said endless conveyor belt with cleaning liquid, wherein said endless conveyor belt passes through a cleaning liquid, wherein excess cleaning liquid can be scraped off, said endless conveyor belt further cleaned with brushes.
